(19) United States
(12) Patent Application Publication
(10) Pub. No.: US 2009/0309351 A1
(43) Pub. Date: Dec. 17, 2009

(54) Reading Supply Device

(76) Inventor: Angela B. Bemiss, Atlanta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/246,300

(22) Filed: Oct. 6, 2008

Related U.S. Application Data
(60) Provisional application No. 61/060,503, filed on Jun. 11, 2008.

(51) Int. Cl. B42D 3/12

(52) U.S. Cl. 281/30; 281/19.1; 281/31; 412/3

(57) ABSTRACT

A reading supply device and a method of making a reading supply device are provided. For example, a reading supply device may include a base unit adapted for coupling to a book. The base unit may include a bottom surface, a top surface, and a writing instrument holder portion. The writing instrument holder portion may include an outer surface and inner surface. The inner surface of the writing instrument holder portion may be coupled to the top surface of the base unit, and the writing instrument holder portion may be dimensioned to receive a writing instrument. Further, the method may include forming a writing instrument holder in the base unit as well as folding the base unit.

### CROSS-REFERENCE TO RELATED APPLICATION

The present application claims priority to U.S. Provisional Patent Application No. 61/060,503 entitled “Reading Supply Device” and filed on Jun. 11, 2008, which is incorporated herein by reference in its entirety.

### TECHNICAL FIELD

The present application is generally related to reading materials and, more particularly, is related to an apparatus and method for holding supplies that are sometimes utilized by readers and other users of books or book-like items.

### BACKGROUND

With existing technology, readers often face the “reader's dilemma” of having to hunt for a pen or pen and paper when desiring to jot down a note and risk forgetting the nugget of information meant to be noted and/or risk losing his or her place in the book. If the reader chooses to locate the pen and paper and make the note, then the reader also has to decide whether to return the pen and paper to their prior locations or hold them while continuing to read. Holding pen and paper while continuing to read can turn into a precarious balancing act, especially aboard a car, bus, train or airplane, and can even result in the pen and paper getting inadvertently lost. In either case, the reader still has to store and remember the location of the paper on which the notes were made.

### BRIEF DESCRIPTION OF THE DRAWINGS

Many aspects of the application can be better understood with reference to the following drawings. The components in the drawings are not necessarily to scale, emphasis instead being placed upon clearly illustrating the principles of various embodiments in the present application. Moreover, in the drawings, like reference numerals designate corresponding parts throughout the several views and/or embodiments.

FIG. 1 is a front perspective view of a nonlimiting example of a first embodiment of a reading supply device.

FIG. 2 is an exploded front perspective of the reading supply device illustrated in FIG. 1.

FIGS. 3A, 3B and 3C are front perspective views of the reading supply device illustrated in FIGS. 1 and 2 at various stages of insertion into a book.

FIG. 3D illustrates an embodiment of a base unit prepared for the construction of the reading supply device illustrated in FIGS. 1, 2, 3A, 3B, and 3C.

FIG. 4 is a cross-sectional view of a reading supply device and a book shown in FIG. 3C taken along 4-4.

FIG. 5 illustrates a perspective view of an embodiment of an upper portion of the base unit of the reading supply device illustrated in FIGS. 1, 2, 3A, 3B, 3C, and 4.

FIG. 6 illustrates a front perspective view of a nonlimiting example of a second embodiment of a reading supply device.

FIG. 7 illustrates a front perspective view of a nonlimiting example of a third embodiment of a reading supply device.

FIG. 8 illustrates a front perspective view of a nonlimiting example of a fourth embodiment of a reading supply device.

FIG. 9 is a flow diagram that describes a nonlimiting example of a first embodiment of a method of making a reading supply device.

FIG. 10 is a flow diagram that describes a nonlimiting example of a second embodiment of a method of making a reading supply device.

FIG. 11 is a flow diagram that describes a nonlimiting example of a first embodiment of forming a writing instrument holder.

FIG. 12 is a flow diagram that describes a nonlimiting example of a second embodiment of forming a writing instrument holder.

### DETAILED DESCRIPTION

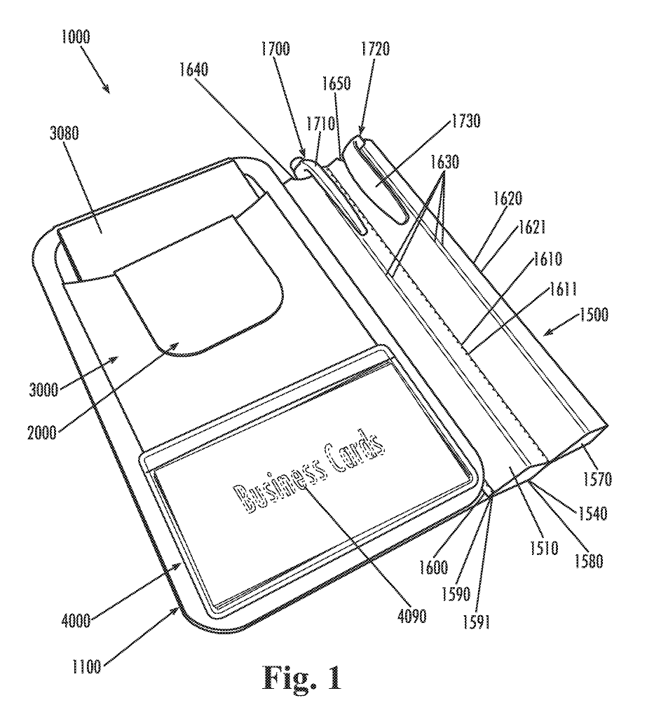

FIG. 1 is a front perspective view of a nonlimiting example of a first embodiment of a reading supply device 1000. The reading supply device 1000 shown includes a base unit 1100, a bookmark 2000, a first card holder 3000, and a second card holder 4000. The base unit 1100 also includes an upper portion 1110 and a lower portion 1140 that can be coupled together, for example, using an upper magnet 1170 and lower magnet 1210. In some embodiments, the base unit 1100 of the reading supply device 1000 may be dimensioned such that the upper portion 1110 and the lower portion 1140 can be inserted into a book. The first card holder 3000 is coupled to the upper portion 1110 and is adapted to store one or more note cards 3080. Similarly, the second card holder 4000 is adapted to store one or more business cards 4090 and is coupled to the upper portion 1110. The base unit 1100 also includes a writing instrument holder 1500, which is adapted to hold a first writing instrument 1700 and a second writing instrument 1720.

With further reference to FIG. 1, the writing instrument holder 1500 includes an inner surface 1540 and an outer surface 1510. As shown in the figure, the writing instrument holder 1500 includes a fold 1621 formed along a writing instrument holder fold line 1620. Also, the writing instrument holder 1500 includes a first divider line 1611 formed along a center line 1610 and a second divider line 1591 formed along a left line 1590. The first divider line 1611 and the second divider line 1591 are coupled so as to define two pockets in the writing instrument holder 1500 adapted to receive the first and second writing instrument 1700, 1720. More specifically, in FIG. 1, the first divider line 1611 and the second divider line 1591 are stitched so as to define the two pockets.

The first pocket includes a first or top opening 1640 and a second or bottom opening 1580. Likewise, the second pocket includes a first or top opening 1650 and a second or bottom opening 1570. Also, the second or bottom openings 1580, 1570 of each pocket are shown in FIG. 1 as being open. In other embodiments, an opening of one or both pockets may be closed. In addition, the closure along the lines 1610 and 1590 may be achieved by sewing, glue, magnets and/or one of a variety of other coupling means.

The writing instruments 1700, 1720 held by the writing instrument holder 1500 may be pens, pencils, highlighters, markers, etc. The writing instrument holder 1500 can prevent a point (e.g., the lead of a pencil) of the writing instrument(s) 1700 and/or 1720 from breaking during storage in the writing instrument holder 1500 by enclosing at least a portion of the point. Further, by enclosing the writing instrument(s) 1700 and/or 1720 in this manner, inadvertent ink or pencil markings and/or snags inside luggage, briefcases, purses, etc. may be avoided because the points of the writing instrument(s) 1700 and/or 1720 are not exposed. In the embodiment illustrated in FIG. 1, the writing instrument(s) 1700, 1720 can be inserted through the openings 1640, 1650 of the pockets, and the writing instruments 1700, 1720 can be removably secured to the writing instrument holder 1500 using a clip(s) 1710, 1730 of the writing instrument(s) 1700, 1720.

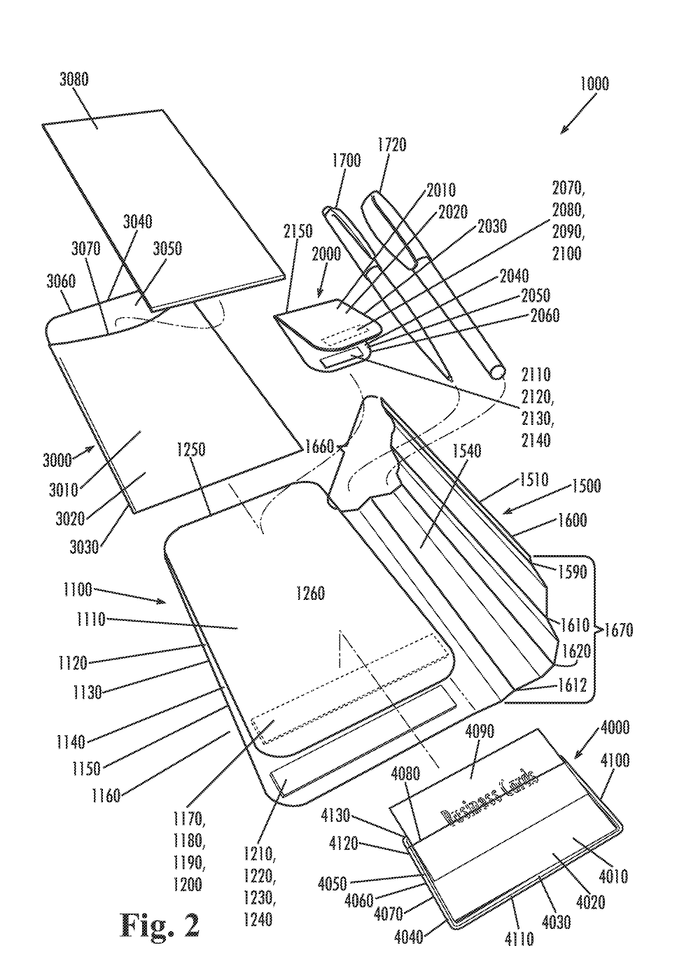

FIG. 2 is an exploded front perspective of the reading supply device 1000 illustrated in FIG. 1. The reading supply device 1000 includes an embodiment of the base unit 1100. The base unit 1100 may be made of a base unit material such as heavyweight paper, plastic, leather, and/or another material. As shown in FIG. 2, the base unit 1100 includes an upper portion 1110, a lower portion 1140, and a writing instrument holder 1500. In some embodiments, the writing instrument holder 1500 illustrated is dimensioned and configured to hold two writing instruments 1700, 1720.

As mentioned above, the reading supply device 1000 shown in FIG. 2 includes a first card holder 3000. In some embodiments, the first card holder 3000 is dimensioned to hold a 3″×5″ note card 3080, and the first card holder 3000 may therefore be referred to as a “note card holder.” The first card holder 3000 includes an upper portion 3010 and a lower portion 3040. The upper portion 3010 of the first card holder 3000 includes a top surface 3020 and a bottom surface 3030. Likewise, the lower portion 3040 of the first card holder 3000 includes a top surface 3050 and a bottom surface 3060. The upper portion 3010 and the lower portion 3040 are connected along their lateral edge and an edge orthogonal to the lateral sides (e.g., bottom edge) such that they form a pouch-like area. A note card 3080 can be inserted into the first card holder 3000 between the upper portion 3010 and the lower portion 3040 of the first card holder 3000. When inserted, a note card 3080 can be positioned between the bottom surface 3030 of the upper portion 3010 and the top surface 3050 of the lower portion 3040.

In the illustrated embodiment, the first card holder 3000 is coupled to the base unit 1100 such that the bottom surface 3060 of the lower portion 3040 of the first card holder 3000 is coupled to the top surface 1120 of the upper portion 1110 of the base unit 1100. The bottom surface 3060 of the lower portion 3040 of the first card holder 3000 may be coupled to the top surface 1120 of the upper portion 1110 of the base unit 1100 using glue, sewing, snap closure, magnets, and/or one of a variety of other attachment means.

In the nonlimiting embodiment illustrated in FIG. 2, the first card holder 3000 is a card holder that may be dimensioned to hold a library card that has been purchased from an office supply store. However, in some embodiments, among others, the first card holder 3000 may be constructed (or fabricated) instead of purchased. For example, the first card holder 3000 may constructed by folding a sheet of base unit material or another material to create a pocket dimensioned for holding the note card 3080. Alternatively, the first card holder 3000 may be constructed by coupling a piece of base unit material or another material dimensioned for accommodating the note card 3080 on three sides to the upper portion 1110 of the base unit 1100, similar to a patch pocket on a pair of pants.

As also described above, the reading supply device 1000 further includes a bookmark 2000. In the embodiment in FIG. 2, the bookmark 2000 shown in FIG. 2 is a magnetic bookmark. In other embodiments, the bookmark 2000 may be a clip-style bookmark or one of a variety of other bookmarks. The bookmark 2000 may be a purchased bookmark. Referring again to FIG. 2, the bookmark 2000 shown includes an upper portion 2010, a lower portion 2040, an upper magnet 2070 and a lower magnet 2110. The bookmark 2000 also includes a fold 2150 between the upper portion 2010 and the lower portion 2040. The upper portion 2010 includes a top surface 2020 and a bottom surface 2030. Likewise, the lower portion 2040 includes a top surface 2050 and a bottom surface 2060. The upper magnet 2070 includes a top surface 2090 and a bottom surface 2100. Similarly, the lower magnet 2110 includes a top surface 2130 and a bottom surface 2140. In some embodiments, the upper magnet 2070 is coupled to the bottom surface 2030 of the upper portion 2010 with an adhesive 2080, while the lower magnet 2110 is coupled to the top surface 2050 of the lower portion 2040 with an adhesive 2120.

Also shown in FIG. 1, the bookmark 2000 is coupled to the upper portion 3010 of the first card holder 3000. Specifically, the bookmark 2000 is coupled to the upper portion 3010 of the first card holder 3000 by positioning the lower magnet 2110 of the bookmark 2000 on the bottom surface 3030 of the upper portion 3010 and the upper magnet 2070 of the bookmark 2000 on the top surface 3020 of the upper portion 3010. The first card holder 3000 may be made of base unit material and/or one of a variety of other materials such that the magnets 2070, 2110 of the bookmark 2000 are magnetically attracted to each other through the upper portion 3010 of the first card holder 3000 as well as through several pages of a book. Thus, the magnets 2070, 2110 are coupled when the magnets 2070, 2110 are positioned as described above with respect to the first card holder 3000. In other embodiments, the bookmark 2000 may be stored in the first card holder 3000 in the same manner that a note card 3080 can be stored. Similarly, in still other embodiments, the bookmark 2000 may be coupled to the second card holder 4000 or stored in the second card holder 4000.

With further reference to FIG. 2, the reading supply device 1000 also includes the second card holder 4000. The second card holder 4000 includes an upper portion 4010 and a lower portion 4040. The upper portion 4010 includes a top surface 4020 and a bottom surface 4030, and similarly, the lower portion 4040 includes a top surface 4050 and a bottom surface 4060. Also, the upper portion 4010 and the lower portion 4040 are coupled along a first side 4100, a second side 4110, and a third side 4120. However, the upper portion 4010 and the lower portion 4040 are not coupled on the fourth side 4130. Thus an opening 4080 on the fourth side 4130 is created between the upper portion 4010 and the lower portion 4040.

In some embodiments, the second card holder 4000 is dimensioned such that a business card 4090 can be inserted between the lower portion 4040 and the upper portion 4010. As a nonlimiting example, the business card 4090 may be a 3.5″×2″ card. When inserted, the business card 4090 is positioned between the bottom surface 4030 of the upper portion 4010 and the top surface 4050 of the lower portion 4040. In the embodiment illustrated in FIG. 2, the upper portion 4010 and/or the lower portion 4040 of the second card holder 4000 are made of a clear or transparent plastic material such that a person could see the business card 4090 when the business card 4090 is inserted in the second card holder 4000. In other embodiments, the material of the upper portion 4010 and/or the lower portion 4040 may be opaque.

As is also shown in FIG. 2, the second card holder 4000 is coupled to the base unit 1100 of the reading supply device 1000. Specifically, the bottom surface 4060 of the lower portion 4040 of the second card holder 4000 is coupled to the upper portion 1110 of the base unit 1100 of the reading supply device 1000. The second card holder 4000 may be coupled to the base unit 1100 using glue, sewing, snap closure, magnets, and/or one of a variety of other attachment means.

In the nonlimiting embodiment illustrated in FIG. 2, the second card holder 4000 is an off-the-shelf business card holder that may be purchased at an office supply store. In other embodiments, the second card holder 4000 may be constructed (or fabricated) instead of purchased. For example, the second card holder 4000 may constructed by folding a sheet of base unit material or another material to create a pocket dimensioned for holding the business card 4090. Alternatively, the second card holder 4000 may be constructed by coupling a piece of base unit material or another material, dimensioned for accommodating the business card 4090, on three sides to the upper portion 1110 of the base unit 1100, similar to a patch pocket on a pair of pants.

In FIG. 2, the first card holder 3000 and the second card holder 4000 are shown as both being coupled to the top surface 1120 of the upper portion 1110 of the base unit 1100 of the reading supply device 1000. The upper portion 1110 of the base unit 1100 is dimensioned to accommodate both the first card holder 3000 and the second card holder 4000. In some embodiments, the reading supply device 1000 may include other card holders coupled to the base unit 1100 in addition to the first card holder 3000 and the second card holder 4000 described above. Also, in some embodiments, one or more card holder(s) may be coupled to the lower portion 1140 of the base unit 1100.

It is noted that other reading supplies may be included in or adhered to the reading supply device 1000. These reading supplies may include, for example, “sticky notes,” “sticky flags,” “sticky tabs,” paper clips, binder clips, correction tape, breath mints, chewing gum, spare lead for a mechanical pencil, ruler, scotch tape, eraser refills, money, and/or one of a variety of other reading supplies.

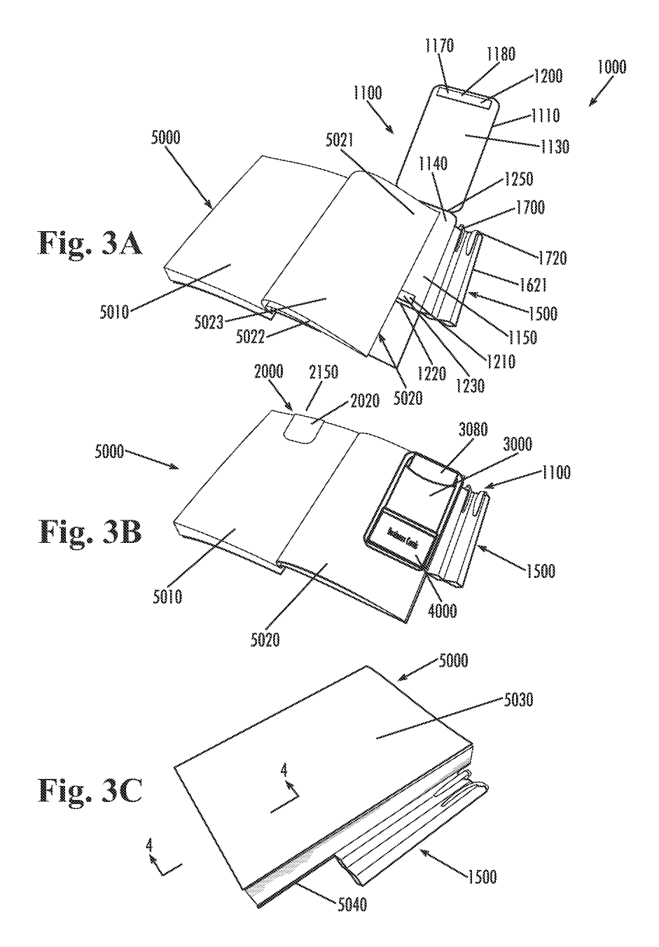

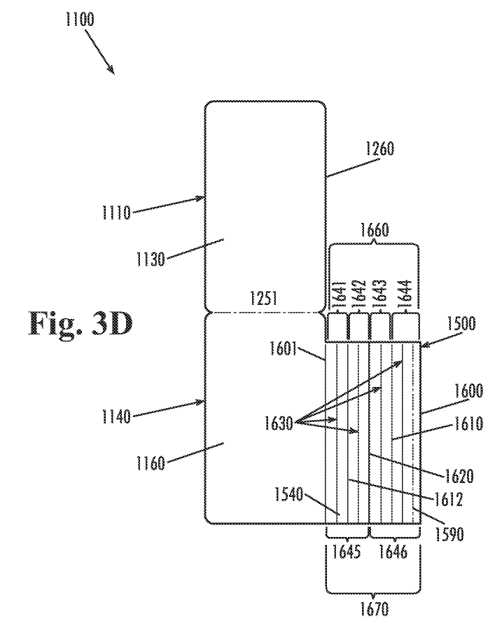

FIGS. 3A, 3B, and 3C are front perspective views of the reading supply device 1000 illustrated in FIGS. 1 and 2 at various stages of insertion into a book 5000. As shown in FIG. 3A, 3B, and 3C, the reading supply device 1000 is dimensioned such that it is smaller than the book 5000. Specifically, the upper portion 1110 and the lower portion 1140 of the base unit 1100 are each adapted to have a height and a width less than the page height and the page width of one or more pages 5020 of the book 5000.

FIG. 3A illustrates the reading supply device 1000 as being in an open orientation (or “state” or “condition”). Specifically, the upper portion 1110 of the base unit 1100 is magnetically decoupled from the lower portion 1140 of the base unit 1100 by having the upper magnet 1170 and the lower magnet 1210 magnetically decoupled from each other. After the magnets 1170, 1210 are magnetically decoupled and the reading supply device 1000 is opened, the lower portion 1140 of the base unit 1100 can be placed underneath the one or more pages 5020, which may be selected by a user. As shown in FIG. 3A, the lower portion 1140 of the base unit 1100 can be positioned at a top right-hand corner of the one or more pages 5020 such that the top surface 1150 of the lower portion 1140 of the base unit 1100 will contact the bottom surface of the page 5020.

Once the reading supply device 1000 is positioned as shown in FIG. 3A, the upper portion 1110 of the base unit 1100 is lowered to the top surface of the one or more pages 5020 as shown in FIG. 3B. When the upper portion 1110 and the lower portion 1140 of the base unit 1100 are close enough to each other, the upper magnet 1170 will be magnetically attracted to the lower magnet 1210 through the one or more pages 5020. Consequently, the upper portion 1110 and the lower portion 1140 of the base unit 1100 will be magnetically coupled together. Hence, the magnetic fields of the upper magnet 1170 and the lower magnet 1210 will removably secure the reading supply device 1000 on one or more pages 5020 as shown in FIG. 3B, and thus, in the book 5000. In some embodiments, several pages in addition to the one or more pages 5020 may lie between the lower magnet 1210 and the upper magnet 1170 when the reading supply device 1000 is coupled to a book.

Once the one or more pages 5020 lies between the magnetically coupled upper portion 1110 and the lower portion 1140, the book 5000 can be closed as shown in FIG. 3C. When the book 5000 is closed, the book front cover 5030 is substantially parallel with the book back cover 5040, and the writing instrument holder 1500 will remain outside the closed book 5000 whereas the upper portion 1110 and the lower portion 1140 of the base unit 1100 of the reading supply device 1000 may be sandwiched within the closed book 5000.

Once a reader inserts the reading supply device 1000 into a book 5000 in the manner illustrated in FIGS. 3A, 3B, and 3C, the reader may use the bookmark 2000 to keep the reader's place in the book 5000. FIG. 3B illustrates the bookmark 2000, magnetically coupled to the top of a left page 5010 of the book 5000. Some readers may find it useful to mark the line where the reader may have stopped reading using the bookmark 2000.

In other embodiments, the reading supply device 1000 may be customized for a left-handed reader. In those embodiments, the writing instrument holder 1500 may be located on the left side of the base unit 1100, and the upper portion 1110 and the lower portion 1140 of the base unit 1100 may be inserted near the beginning pages of the book 5000 instead of near the final pages of the book as shown in FIGS. 3A-3C. When the book 5000 is closed, the book front cover 5030 is substantially parallel with the book back cover 5040, and the writing instrument holder 1500 will remain outside the closed book 5000 whereas substantially the rest of the base unit 1100 of the reading supply device 1000 may be sandwiched within the closed book 5000.

Thus, the reading supply device 1000 may provide a reader easy access to writing instruments, business cards, note cards, and/or a bookmark while the reader may be holding the book. The reading supply device 1000 may also provide a way to secure these items and help prevent these items from inadvertently being lost. Further, the reading supply device 1000 may be sturdy yet light and portable. Moreover, the reading supply device 1000 can be collapsed and/or flattened into a form for storage when the writing instrument(s) 1700 and/or 1720 have been removed.

When useful, the writing instruments, paper, business cards, bookmark, note cards, sticky notes, etc. may be placed in the reading supply device 1000 when the reading supply device 1000 is inserted in a book or when the reading supply device 1000 is not inserted in a book 5000. When inserting the paper, business cards, bookmark, note cards, sticky notes, etc., the book 5000 may need to be opened. However, the book 5000 may not need to be opened when writing instruments are inserted into the writing instrument holder 1500.

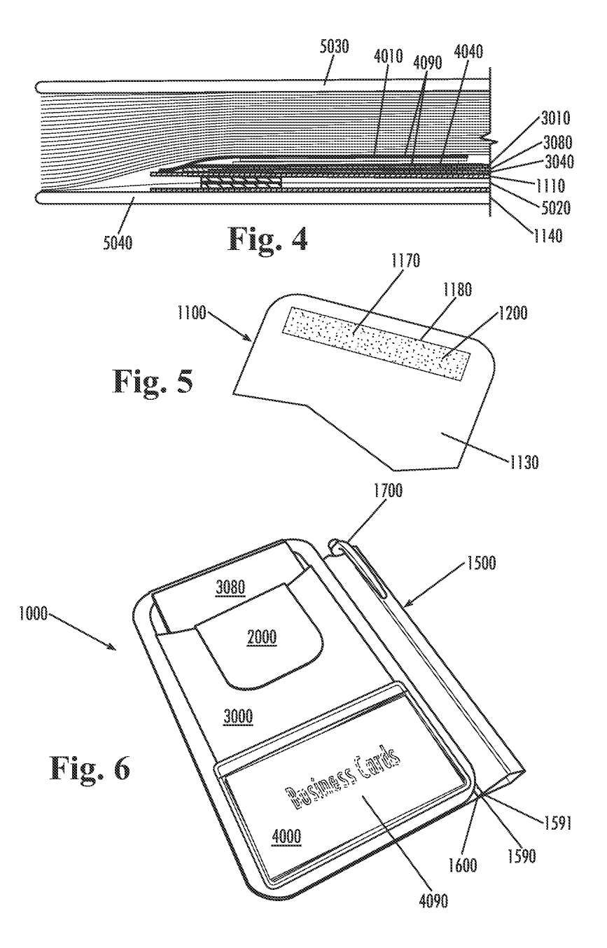

FIG. 4 is a cross-sectional view of a reading supply device and a book shown in FIG. 3C taken along 4-4. The various layers shown, from top to bottom in the orientation of the figure, are as follows: a book front cover 5030, a second card holder upper portion 4010, business cards (two) 4090, second card holder lower portion 4040, a first card holder upper portion 3010, note card 3080, a first card holder lower portion 3040, the upper portion 1110 of the base unit 1100, the page 5020, the lower portion 1140 of the base unit 1100, and the book back cover 5040.

FIG. 5 illustrates a front perspective view of an embodiment of the upper portion 1110 of the base unit 1100 of the reading supply device 1000 illustrated in FIGS. 1, 2, 3A, 3B, 3C, and 4. The upper magnet 1170 includes a top surface 1190 and a bottom surface 1200. The top surface 1190 of the upper magnet 1170 is coupled to the bottom surface 1130 of the upper portion 1110 of the base unit 1100 by an upper magnet adhesive 1180.

FIG. 6 illustrates a nonlimiting second embodiment of a reading supply device 1000. FIG. 6 illustrates a first writing instrument 1700 inserted into the pocket of the writing instrument holder 1500. Similar to the embodiment of a reading supply device 1000 discussed above, this embodiment includes a first card holder 3000, note card(s) 3080, a second card holder 4000, and a bookmark 2000. However, the writing instrument holder 1500 in the embodiment illustrated in FIG. 6 is adapted to hold only one writing instrument 1700.

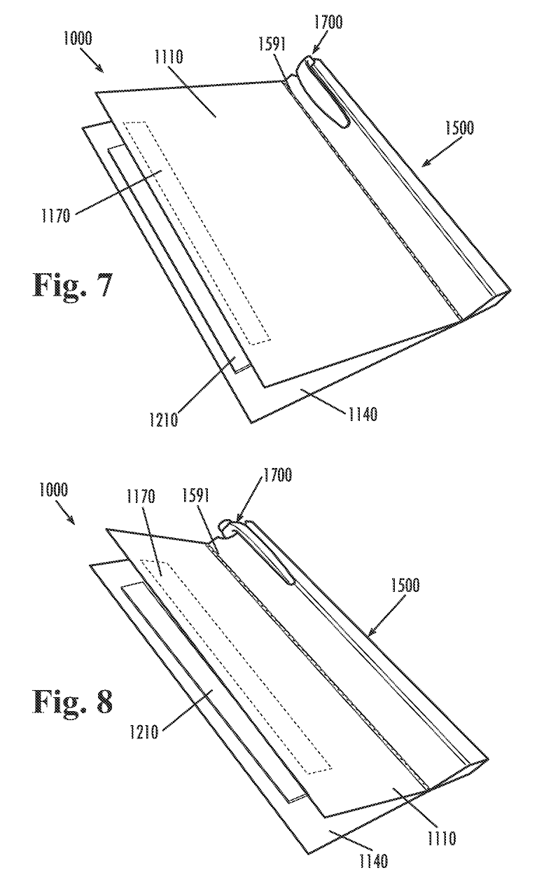

FIG. 7 illustrates a front perspective view of a nonlimiting example of a third embodiment of a reading supply device 1000. The reading supply device 1000 depicted in FIG. 7 includes an upper portion 1110 and a lower portion 1140 of a base unit 1100. An upper magnet 1170 is coupled to the upper portion 1110, and a lower magnet 1210 is coupled to the lower portion 1140. Also included in the base unit 1100 is a writing instrument holder 1500. Like the first and second embodiments, the third embodiment of the reading supply device 1000 is dimensioned such that the upper portion 1110 and the lower portion 1140 are each dimensioned to have a height and width less than the page height and the page width of the page 5020 of the book 5000. However, the third embodiment does not include a first card holder 3000, a second card holder 4000, or a bookmark 2000.

FIG. 8 illustrates a front perspective view of a nonlimiting example of a fourth embodiment of a reading supply device 1000. The reading supply device 1000 is similar to the third embodiment depicted in FIG. 8, except that the upper portion 1110 is dimensioned such that the height of the upper portion 1110 is greater than the height of the upper magnet 1170. Additionally, the lower portion 1140 is dimensioned such that the height of the lower portion 1140 is greater than the height of the lower magnet 1210. Further, the upper portion 1110 is dimensioned such that the width of the upper portion 1110 is greater than the width of the upper magnet 1170. Also, the lower portion 1140 is dimensioned such that the lower portion 1140 is greater than the width of the lower magnet 1210.

The writing instrument holder 1500, the upper portion 1110, and/or lower portion 1140 may be formed from a single base unit material, and a second divider line 1591 may be stitched on the base unit 1100 between the upper portion 1110 and the lower portion 1140. In other embodiments, among others, the writing instrument holder 1500 may be formed from a base unit material separate from the base unit material used to form the upper portion 1110 and/or the lower portion 1140 of the base unit 1100. In those embodiments, the writing instrument holder 1500 may be stitched to the base unit 1100 at the second divider line 1591. Further, in the embodiment depicted in FIG. 7, although not illustrated, a first card holder 3000, second card holder 4000, and/or bookmark 2000 may be coupled to the upper portion 1110 and/or the lower portion 1140 of the base unit 1100.

In some embodiments, among others, the reading supply device 1000 may include a base unit magnet, which may be one of the upper magnet 1170 and/or the lower magnet 1210. Also, in those embodiments, the reading supply device 1000 may also include another magnet, which may be the other one of the upper magnet 1170 and/or the lower magnet 1210. Further, the base unit 1100 may include one of the upper portion 1110 and/or the lower portion 1140.

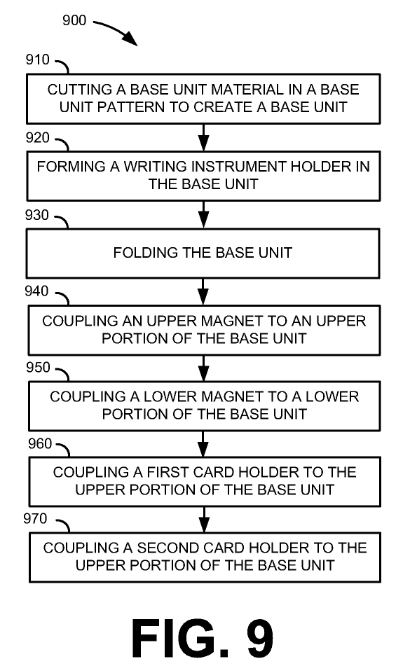

FIG. 9 is a flow diagram that describes a nonlimiting example of a first embodiment of a method 9000 of making a reading supply device 1000. Reference will be made to the reading supply device 1000 illustrated in FIGS. 1, 2, 3D and/or 6 in the following discussion of the method 900 depicted in FIG. 9. The method 900 of making a reading supply device 10000 may include blocks 910, 920, 930, 940, 950, 960, and/or 970.

In block 910, a base unit material is cut according to a base unit pattern to create a base unit 1100. FIG. 3D illustrates the base unit 1100 as it is initially prepared for the construction of the reading supply device 1000. Specifically, the base unit 1100 is cut from a base unit material into the shape of a base unit 1100 as shown in the nonlimiting example in FIG. 3D. The base unit material may be a flat material, such as heavyweight paper, plastic, leather, a file folder and/or another material. The file folder may be particularly useful as a base unit material because the file folder already includes a fold, which may be used as the fold line 1250 of the base unit 1100. Further, the file folder may be conveniently purchased and may offer a useful size. As indicated in FIG. 3D, a piece of a base unit material can be cut and removed by cutting alongside the right side 1260 of the upper portion 1110 of the base unit 1100 and the head portion 1660 of the writing instrument holder 1500 of the base unit 1100.

Once the base unit material has been cut according to a base unit pattern, the base unit 1100 includes a writing instrument holder portion and a remainder portion. With reference to FIG. 3D, the writing instrument holder portion includes the portion of the base unit 1100 to the right of line 1601. The remainder portion includes the portion of the base unit 1100 to the left of the line 1601. Hence, the remainder portion includes the upper portion 1110 and/or the lower portion 1140 of the base unit 1100.

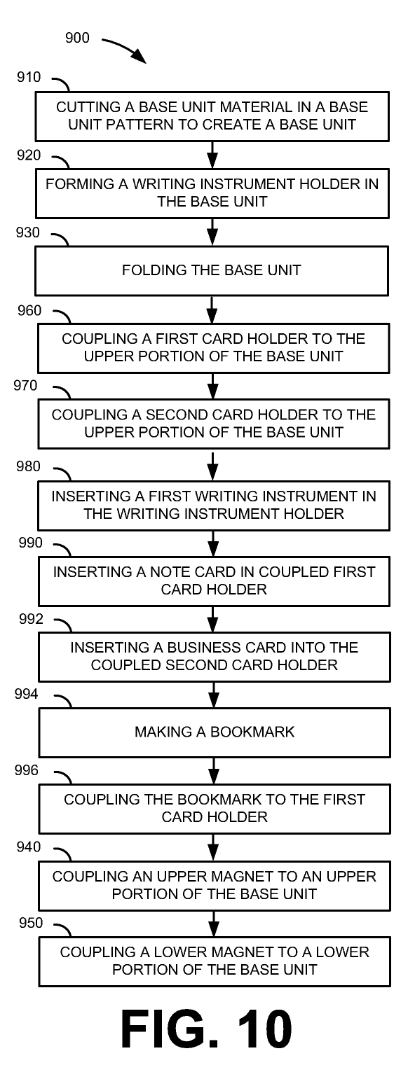

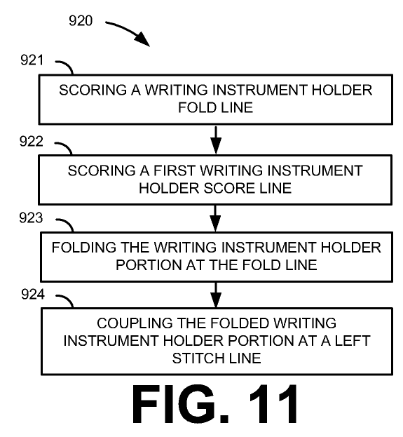

In block 920, a writing instrument holder 1500 is formed in the base unit 1100. FIG. 11 is a flow diagram that describes a nonlimiting example of a first embodiment of block 920. Block 920 is included in the first and second embodiments of the method 900 of making a reading supply device 1000 described in FIGS. 9 and 10. In block 921, a writing instrument holder fold line 1620 on the writing instrument holder portion of the base unit 1100 is scored. The writing instrument holder fold line 1620 is scored such that the base unit material of the base unit 1100 may be folded at the writing instrument holder fold line 1620 but not cut into separate pieces.

In block 922, a first writing instrument holder score line is scored. The first writing instrument holder score line is one of the score lines 1630 shown in FIG. 1. The first writing instrument holder score line is scored such that the writing instrument holder 1500 may bend but not separate at the first writing instrument holder score line. The score lines 1630 can provide a rounded dimension to the writing instrument holder 1500 and a flexible pocket that facilitates the easy insertion of a writing instrument 1700.

In block 923, the writing instrument holder portion is folded at the writing instrument holder fold line 1620. In block 924, the writing instrument holder portion is coupled to the remainder portion of the base unit 1100 at the left line 1590 to form the second divider line 1591. In the nonlimiting first embodiment illustrated in FIGS. 1 and 2 above, the writing holder portion is coupled by stitching to the remainder portion of the base unit 1100.

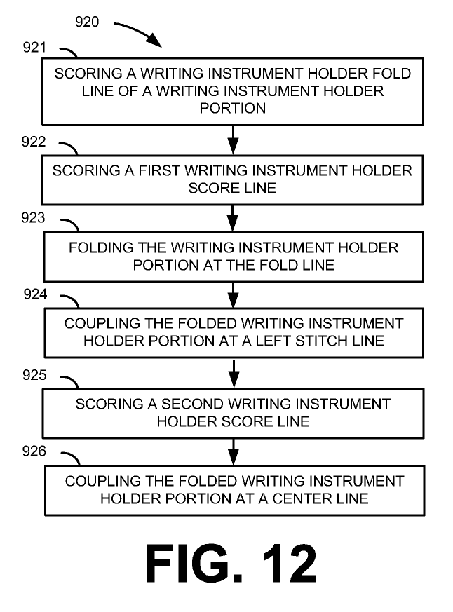

FIG. 12 is a flow diagram that describes a nonlimiting example of a second embodiment of block 920. As depicted in FIG. 12, block 920 further includes blocks 925 and 926 in addition to blocks 921, 922, 923 and 924 described above with respect to FIG. 11. In block 925, a second writing instrument holder score line is scored. The second writing instrument holder score line may at least be one of the score lines 1630 and in addition to the first writing instrument holder score line. In some embodiments of method 900, block 920 may be performed such that the blocks 921, 922, 925, which each include items being scored, are performed with no intervening blocks to possibly improve efficiency.

In block 926, the writing instrument holder portion is coupled at a center line 1610 to form a writing instrument holder 1500 adapted to hold a first writing instrument 1700 as well as a second writing instrument 1720. In the nonlimiting first embodiment illustrated in FIGS. 1 and 2 above, the writing holder portion is coupled along the first divider line 1611 at the center line 1610 to form the writing instrument holder 1500 adapted to hold the first writing instrument 1700 as well as the second writing instrument 1720. The scoring of the center line 1610 may occur prior to the coupling of the writing instrument holder portion at the center line 1610.

Referring again to FIG. 9, the base unit 1100 is folded according to block 930. For example, the base unit 1100 may be folded horizontally to form the fold line 1250. The fold line 1250 defines the upper portion 1110 and the lower portion 1140 of the base unit 1100. In some embodiments, a base unit score line 1251 may be scored. The base unit 1100 may later be folded at the base unit score line 1251 to form a fold line 1250.

In block 940, an upper magnet 1170 is coupled to the upper portion 1110 of the base unit 1100. For example, as illustrated in FIG. 2, the upper magnet 1170 is coupled to the bottom surface 1130 of the upper portion 1110 of the base unit 1100. The upper magnet 1170 may be coupled by glue, sewing, adhesive, or one of a variety of attachment means. In some embodiments, the upper magnet 1170 may be concealed within the upper portion 1110 when coupled to upper portion 1110 of the base unit 1100.

In block 950, a lower magnet 1210 is coupled to the lower portion 1140 of the base unit 1100. For example, as illustrated in FIG. 2, the lower magnet 1210 is coupled to the top surface 1150 of the lower portion 1140 of the base unit 1100. In some embodiments, the lower magnet 1210 may be concealed within the lower portion 1140 when the lower magnet 1210 is coupled to the base unit 1100. The lower magnet 1210 may be coupled by glue, sewing, adhesive, or one of a variety of attachment means. When the base unit 1100 is folded at fold line 1250, the reading supply device 1000 can be removably secured in a book 5000 (as shown in FIGS. 3A, 3B and 3C) because the upper magnet 1170 and the lower magnet 1210 are magnetically coupled to each other.

In block 960, a first card holder 3000 is coupled to the upper portion 1110 of the base unit 1100. For example, the first card holder 3000 may be coupled to the top surface 1120 of the upper portion 1110 of the base unit 1100 as illustrated in FIGS. 1 and 2. The first card holder 3000 may be coupled to the upper portion 1110 of the base unit 1100 by glue, sewing, adhesive, or one of a variety of attachment means. The first card holder 3000 may be constructed for the reading supply device 1000 or purchased from an office supply store. For example, a purchased library card holder may be a first card holder 3000. The details regarding the construction of a first card holder 3000 are discussed above.

In block 970, a second card holder 4000 is coupled to the upper portion 1110 of the base unit 1100. For example, the second card holder 4000 may be coupled to the top surface 1120 of the upper portion 1110 of the base unit 1100 as illustrated in FIGS. 1 and 2. Also as illustrated in FIGS. 1 and 2, the upper portion 1110 of the base unit 1100 is dimensioned to accommodate both a first card holder 3000 and/or a second card holder 4000 coupled thereon. The second card holder 4000 may be coupled to the upper portion 1110 of the base unit 1100 by glue, sewing, adhesive, magnets or one of a variety of attachment means.

In some embodiments, blocks 940 and 950 may be performed after the second card holder 4000 is coupled to the upper portion 1110 of the base unit 1100. When the upper magnet 1170 and/or the lower magnet 1210 is coupled to the base unit 1100 before the second card holder 4000 is coupled to base unit 1100, wrinkles may be inadvertently imprinted on the second card holder 4000. These imprinted wrinkles may be avoided by the upper magnet 1170 and/or the lower magnet 1210 being coupled to the base unit 1100 after the second card holder 4000 is coupled to base unit 1100,

FIG. 10 is a flow diagram that describes a nonlimiting example of a second embodiment of a method 9000 of making a reading supply device 10000. In addition to blocks may include blocks 910, 920, 930, 940, 950, 960, and/or 970 described above with respect to FIG. 9, the method 900 in the nonlimiting example depicted in FIG. 10 may also include blocks 980, 990, 992, 994, and/or 996. In block 980, a first writing instrument 1700 is inserted in the writing instrument holder 1500. In block 990, a note card 3080 is inserted in the coupled first card holder 3000. In block 992, a business card is inserted into the coupled second card holder 4000.

In block 994, a bookmark 2000 is constructed. For example, the bookmark 2000 illustrated in FIGS. 1 and 2 is a magnetic bookmark. The magnetic bookmark may be constructed by cutting a piece of base unit material, heavyweight paper or other sturdy material, folding it in half vertically on the fold line 2150, adhering an upper magnet 2070 to the bottom surface 2030 of the upper portion 2010, and adhering a lower magnet 2110 to the top surface 2050 of the lower portion 2040. The bookmark 2000 may be placed on or coupled to the top opening 3070 of the first card holder 3000.

In block 996, the bookmark 2000 is coupled to the first card holder 3000. In other embodiments, the bookmark 2000 may be stored in the first card holder 3000. Still, in other embodiments, the bookmark 2000 may be stored in or coupled to the second card holder 4000.

The writing instrument holder 1500 is described above as being formed from a writing instrument portion of the base unit 1100, which is cut from a single base unit material. However, in some embodiments, the writing instrument holder 1500 may be a separate piece of base unit material that is coupled to the upper portion 1110 and/or the lower portion 1140 of the base unit 1100 during the construction process.

The paragraphs above describe one example of a way to construct one embodiment of a reading supply device 1000. Other ways may be employed to construct the reading supply device 1000 as well. Likewise, the procedure described above need not proceed in the order described above. Various actions may occur before other actions or take place concurrently, if possible.

Additionally, in the foregoing description, when items are coupled, the coupling may be accomplished using glue, sewing, adhesive, magnets (where appropriate), by molding or heat-sealing pieces together, or one of a variety of attachment means. The sewing (e.g., stitching) may be performed using a consumer-type model of sewing machine using readily available colored thread and/or readily available “invisible” thread. Also, when items are scored, the scoring may be performed using a dull knife, a scissors, a scoring blade and/or one or more of a variety of scoring utensils.

The reading supply device 1000 may be portable, lightweight, easy-to-use, repositionable, and multi-purpose. It may be used by both readers and writers as well as by people of all ages and in many settings. Further, the reading supply device 1000 may be useful for business people, students, teachers, lecturers/speakers, ministers, musicians, cooks, choir members, doctors, dentists, nurses, travelers, lawyers, hospital patients and marketers. Additionally, the reading supply device 1000 may be “branded” and used as promotional or marketing materials. For example, the trademark of a company may be represented on the base unit 1100 in order to advertise the company.

The reading supply device 1000 may be used with a variety of supplies and can easily be refilled. For example, the first card holder 3000 of the reading supply device 1000 may be refilled with standard 3″×5″ index cards. Likewise, the second card holder 4000 may be refilled with standard 3.5″×2″ business cards. Additionally, the reading supply device 1000 can receive or be refilled with a variety of pens, pencils, highlighters, and sticky notes.

The reading supply device 1000 may address the “reader's dilemma.” The reading supply device 1000 contains a place to keep a pen and paper. The reading supply device 1000 may remain secure when inserted in a book. Additionally, the reading supply device 1000 may include other features that readers will appreciate, including a bookmark 2000 and a holder for business cards and/or other small items frequently used by a reader. Examples of the other small items include “sticky notes,” “sticky flags,” or even money.

It should be emphasized that the above-described embodiments of are merely possible examples of implementations, simply set forth for a clear understanding of the principles. Many variations and modifications may be made to the above-described embodiment(s) of the application without departing substantially from the spirit and principles described in the application.

1. A reading supply device, comprising:
a base unit adapted for coupling to a book, the base unit including a bottom surface, a top surface, and a writing instrument holder portion, the writing instrument holder portion including an outer surface and inner surface, the inner surface of the writing instrument holder portion being coupled to the top surface of the base unit, and the writing instrument holder portion being dimensioned to receive a writing instrument.

2. The reading supply device of claim 1, wherein the base unit includes a base unit magnet coupled to the base unit, and wherein the reading supply device further comprises a magnet capable of being magnetically coupled to the base unit magnet.

3. A reading supply device, comprising:
a base unit comprising a base unit lower portion and base unit upper portion, the base unit being dimensioned for insertion in a book; and
a writing instrument holder dimensioned for receiving a writing instrument coupled to the base unit.

4. The reading supply device of claim 3, further comprising a first card holder coupled to the base unit upper portion, the first card holder being adapted to receive a note card.

5. The reading supply device of claim 4, wherein the base unit upper portion includes a top surface, wherein the first card holder is coupled to the top surface of the base unit upper portion.

6. The reading supply device of claim 4, further comprising a second card holder coupled to the base unit upper portion, wherein the second card holder includes a transparent material and is adapted to receive a business card.

7. The reading supply device of claim 6, wherein the base unit upper portion is further dimensioned to receive a first card holder and a second card holder.

8. The reading supply device of claim 7, wherein the first card holder is adapted to receive a 3″×5″ note card, and the second card holder is adapted to receive a 3.5″×2″ business card.

9. The reading supply device of claim 7, wherein the base unit upper portion includes a top surface, and wherein the second card holder is coupled to the top surface of the base unit upper portion.

10. The reading supply device of claim 3, wherein an upper magnet is coupled to the base unit upper portion, wherein a lower magnet is coupled to the base unit lower portion, and wherein the position of the lower magnet on the base unit lower portion corresponds to the position of the upper magnet on the base unit upper portion.

11. The reading supply device of claim 10, wherein the upper magnet is coupled to a bottom surface of the base unit upper portion, and wherein the lower magnet is coupled to a top surface of the base unit lower portion.

12. The reading supply device of claim 10, wherein the upper magnet is concealed within the base unit upper portion, and wherein the lower magnet is concealed within the base unit lower portion.

13. A method of making a reading supply device, comprising:
cutting a base unit material in a base unit pattern to create a base unit, the base unit including a writing instrument holder portion and a remainder portion, the writing instrument holder being dimensioned to receive a writing instrument, and the remainder portion being dimensioned for insertion in a book;
forming a writing instrument holder adapted to receive a writing instrument in the base unit; and
folding the base unit.

14. The method of claim 13, wherein forming the writing instrument holder comprises:
scoring a writing instrument holder fold line of the writing instrument holder portion;
scoring a first writing instrument holder score line;
folding the writing instrument holder portion at the writing instrument holder fold line; and
coupling the folded writing instrument holder portion at a left line and defining an pocket in the writing instrument holder for receiving a writing instrument.

15. The method of claim 14, wherein forming the writing instrument holder further comprises:
scoring a second writing instrument holder score line; and
coupling the folded writing instrument holder portion at a center line to form a writing instrument holder adapted to hold a first writing instrument and a second writing instrument.

16. The method of claim 13, further comprising coupling the first card holder to the base unit upper portion, the first card holder being adapted to receive a note card.

17. The method of claim 16, wherein coupling the first card holder to the upper portion of the base unit further comprises coupling the first card holder to the top surface of the base unit upper portion.

18. The method of claim 13, further comprising coupling the second card holder to the base unit upper portion, the second card holder being adapted to receive a business card.

19. The method of claim 18, wherein the base unit upper portion is dimensioned to accommodate the first card holder and the second card holder, and wherein the coupling of the second card holder to the base unit upper portion further comprises coupling the first card holder to the top surface of the base unit upper portion.

20. The method of claim 13, further comprising:
coupling an upper magnet to the bottom surface of the base unit upper portion; and
coupling a lower magnet to the top surface of the base unit lower portion.
